(19) United States
(12) Patent Application Publication
(10) Pub. No.: US 2017/0089190 A1
(43) Pub. Date: Mar. 30, 2017

(54) FRACTURE CONDUCTIVITY PREDICTION TOOL

(71) Applicant: Halliburton Energy Services, Inc., Houston, TX (US)

(72) Inventors: Rama Subba Reddy Thavva, Kadapa (IN); Rajender Salla, Pune (IN); Jag Pravesh, Pune (IN)

(21) Appl. No.: 14/871,673

(22) Filed: Sep. 30, 2015

(51) Int. Cl. E21B 43/267; E21B 43/26; G06F 17/50; E21B 49/00

(52) U.S. Cl. CPC E21B 43/267; E21B 49/00; E21B 43/26; G06F 17/5009

(57) ABSTRACT

An example method may include determining one or more characteristics of a proppant, a subterranean formation, and a fracture within the subterranean formation. A void fraction associated with the proppant may be calculated using at least one determined proppant characteristic, at least one determined subterranean formation characteristic, and a model with a known arrangement of the proppant. A fracture conductivity associated with the fracture and the proppant may be predicted based, at least in part, on the calculated void fraction and at least one determined fracture characteristic. The proppant may be selected based, at least in part, on the predicted fracture conductivity. The selected proppant may be introduced into the subterranean formation.

### BACKGROUND

The present disclosure relates generally to well drilling, evaluation, completion and/or production operations and, more particularly, to a fracture conductivity prediction tool.

Hydrocarbons, such as oil and gas, are commonly obtained from subterranean formations that may be located onshore or offshore. The development of subterranean operations and the processes involved in removing hydrocarbons from a subterranean formation are complex. Typically, subterranean operations involve a number of different steps such as, for example, drilling a wellbore through and/or into the subterranean formation at a desired well site, treating the wellbore to optimize production of hydrocarbons, and performing the necessary steps to produce and process the hydrocarbons from the subterranean formation. Treating the wellbore to optimize production may include hydraulic fracturing and stimulation operations that induce fractures in the formation to facilitate hydrocarbon flow.

In some fracturing and stimulation operations, proppants (e.g., treated sand or man-made ceramic materials) are introduced into a fracture during or after the fracturing treatment to hold the fracture open. Properties of the proppant may affect the ease with which hydrocarbons flow through an induced fracture, referred to as fracture conductivity, which may, in turn, affect the performance of the well. Predictions regarding the conductivity of a fracture containing different types of proppants may be used when planning fracturing and stimulation operations to select an appropriate proppant. However, such predictions are typically generated through manual experimentation by placing different proppants into conductivity cells. This can be costly and time-consuming, particularly when many different proppant types and formation conditions must be tested. Additionally, during such manual experimentation Ohio sand stone or standard sand stone is typically used to represent the fracture faces, so the tests do not account for the effect of other reservoir rock properties on fracture conductivity.

### FIGURES

Some specific exemplary embodiments of the disclosure may be understood by referring, in part, to the following description and the accompanying drawings.

FIG. 1 is a diagram of an example well system for fracturing and stimulation operations, according to aspects of the present disclosure.

FIGS. 2A and 2B are diagrams illustrating a graphical representation of an example mathematical model used in a fracture conductivity prediction tool, according to aspects of the present disclosure.

FIG. 3 is a flow diagram depicting an example method, according to aspects of the present disclosure.

FIG. 4 is a diagram illustrating an example information handling system in which the process/model may be implemented, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like. “Measurement-while-drilling” (“MWD”) is the term generally used for measuring conditions downhole concerning the movement and location of the drilling assembly while the drilling continues. “Logging-while-drilling” (“LWD”) is the term generally used for similar techniques that concentrate more on formation parameter measurement. Devices and methods in accordance with certain embodiments may be used in one or more of wireline (including wireline, slickline, and coiled tubing), downhole robot, MWD, and LWD operations.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. As used herein, a processor may comprise a microprocessor, a microcontroller, a digital signal processor (DSP), an application specific integrated circuit (ASIC), or any other digital or analog circuitry configured to interpret and/or execute program instructions and/or process data for the associated tool or sensor. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. It may also include one or more interface units capable of transmitting one or more signals to a controller, actuator, or like device.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

The terms “couple” or “couples” as used herein are intended to mean either an indirect or a direct connection. Thus, if a first device couples to a second device, that connection may be through a direct connection, or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections. Finally, the term “fluidically coupled” as used herein is intended to mean that there is either a direct or an indirect fluid flow path between two components.

According to aspects of the present disclosure, a fracture conductivity prediction tool may be used to estimate fracture conductivity associated with a particular proppant based on a mathematical model of the proppant and a fracture within a formation. The estimate may be performed using ideal representations of the fracture, formation and proppant, or using actual measurements. The estimate may be performed as part of a planning operation, or in real-time during a fracturing and stimulation operation based on downhole measurements. One or more proppants may be selected based, at least in part, on the predicted fracture conductivity to be introduced into a borehole/fracture as part of a fracturing and stimulation operation.

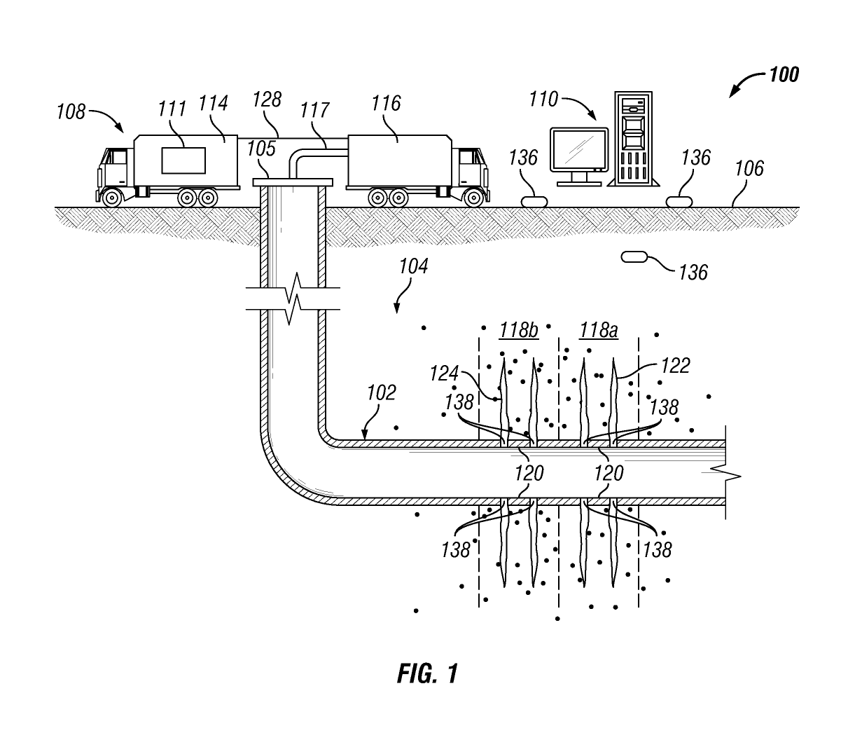

FIG. 1 is a diagram of an example well system 100 configured for fracturing and stimulation operations using one or more proppants selected using a fracture conductivity prediction tool, according to aspects of the present disclosure. The example well system 100 includes a wellbore 102 in a subterranean region 104 beneath the ground surface 106. The example wellbore 102 shown in FIG. 1 includes a horizontal wellbore. However, a well system may include any combination of horizontal, vertical, slant, curved, or other wellbore orientations. In certain embodiments, a horizontal well may be substantially parallel with the principal stress of the subterranean region 104 to provide maximum fracture extension during certain stimulation operations. The well system 100 can include one or more additional treatment wells, observation wells, or other types of wells. The example subterranean region 104 may include a reservoir that contains hydrocarbon resources, such as oil, natural gas, or others. For example, the subterranean region 104 may include all or part of a rock formation (e.g., shale, coal, sandstone, granite, or others) that contain natural gas. The subterranean region 104 may include naturally fractured rock or natural rock formations that are not fractured to any significant degree. The subterranean region 104 may include tight gas formations of low permeability rock (e.g., shale, coal, or others).

As depicted, the example well system 100 includes an injection system 108. The injection system 108 includes instrument trucks 114, pump trucks 116, and an injection control system 111. The injection system 108 may include other features not shown in the figures. The injection system 108 may apply injection treatments that include, for example, a single-stage injection treatment, a multi-stage injection treatment, a mini-fracture test treatment, a follow-on fracture treatment, a re-fracture treatment, a final fracture treatment, other types of fracture treatments, or a combination of these.

The pump trucks 116 can include mobile vehicles, immobile installations, skids, hoses, tubes, fluid tanks, fluid reservoirs, pumps, valves, mixers, or other types of structures and equipment. The pump trucks 116 can supply treatment fluid or other materials for the injection treatment. The pump trucks 116 may contain multiple different treatment fluids, proppant materials, or other materials for different stages of a stimulation treatment. The pump trucks 116 can communicate treatment fluids into the wellbore 102, for example, through a conduit, at or near the level of the ground surface 106. The treatment fluids can be communicated through the wellbore 102 from the ground surface 106 level by a conduit installed in the wellbore 102. The conduit may include casing cemented to the wall of the wellbore 102. In some implementations, all or a portion of the wellbore 102 may be left open, without casing. The conduit may include a working string, coiled tubing, sectioned pipe, or other types of conduit.

The instrument trucks 114 can include mobile vehicles, immobile installations, or other suitable structures. The example instrument trucks 114 include an injection control system 111 that controls or monitors the stimulation treatment applied by the injection system 108. The communication links 128 may allow the instrument trucks 114 to communicate with the pump trucks 116, or other equipment at the ground surface 106. Additional communication links may allow the instrument trucks 114 to communicate with sensors or data collection apparatus in the well system 100, remote systems, other well systems, equipment installed in the wellbore 102 or other devices and equipment.

The injection control system 111 may control operation of the injection system 108. The injection control system 111 may include an information handling system, data processing equipment, communication equipment, or other systems that control stimulation treatments applied to the subterranean region 104 through the wellbore 102. The injection control system 111 may include or be communicably linked to an information handling system 110 of the well system 100 that can calculate, select, or optimize fracture treatment parameters for initialization, propagation, or opening fractures in the subterranean region 104. The injection treatment control system 111 may receive, generate or modify a stimulation treatment plan (e.g., a pumping schedule) that specifies properties of a stimulation treatment to be applied to the subterranean region 104.

The information handling system 110 of the well system 100 may comprise one or more computing devices or systems located at or near the wellbore 102, or away from the wellbore 102. For example, all or part of the computing system 110 can be contained in a technical command center at the well site, in a real-time operations center at a remote location, in another appropriate location, or any suitable combination of these. The well system 100 and the information handling system 110 can include or access any suitable communication infrastructure. For example, well system 100 can include multiple separate communication links or a network of interconnected communication links. The communication links can include wired or wireless communications systems. For example, sensors 136 of the well system 100 may communicate with the instrument trucks 114 or the computing subsystem 110 through wired or wireless links or networks, or the instrument trucks 114 may communicate with the information handling system 110 through wired or wireless links or networks. The communication links can include a public data network, a private data network, satellite links, dedicated communication channels, telecommunication links, or any suitable combination of these and other communication links The well system 100 can include additional or different features, and the features of the well system can be arranged as shown in FIG. 1 or in another configuration.

The injection system 108 can be used to perform a stimulation treatment that includes, for example, an injection treatment and a flow back treatment. During an injection treatment, fluid is injected into the subterranean region 104 through the wellbore 102. In some instances, the injection treatment fractures part of a rock formation or other materials in the subterranean region 104. In such examples, fracturing the rock may increase the surface area of the formation, which may increase the rate at which the formation conducts fluid resources to the wellbore 102. The fluid injected into the subterranean region 104 may include one or more proppants, or one or more proppants may be introduced into the wellbore 102 after the initial injection treatment, to increase the conductivity associated with a particular fracture and the formation generally. The proppants may be selected using a fracture conductivity prediction tool, described in detail below, to optimize the fracture conductivity.

As depicted, the injection treatment comprises a multi-stage injection treatment in which a first injection treatment is performed at a first stage or interval 118a and a second injection treatment is performed at a second stage or interval 118b. The stages 118a and 118b may each have one or more perforation clusters 120 through which fractures 122 and 124 have been respectively generated by the injection treatments. In certain embodiments, each of the stages 118a and 118b and corresponding fractures may be formed with different treatment fluids and use different proppants. For instance, the first treatment stage 118a may be formed and use a proppant that was selected using a fracture conductivity prediction tool before the multi-stage injection treatment operation commenced. The selection may occur before, during, or after the drilling operation to create the wellbore 102, using idealized properties of the subterranean region 104, or properties determined from logging operations that occurred before, during, or after the drilling operation. The second treatment stage 118b, which may occur after the first treatment stage 118a, may be formed and using the same proppant used for the first retreatment stage 118a, or a different proppant selected after the first treatment stage 118a is completed. For instance, the proppant may be selected based, at least in part, on measurements related to the size, shape, and orientation of the fractures 122 generated during the first treatment stage 118a using the sensors 136.

The proppant selection described above may be performed using a fracture conductivity prediction tool implemented in one or more of the information handling systems of the well system 100, e.g., the injection control system 111 or information handling system 110. The proppant selection may also be performed using a fracture conductivity prediction tool implemented in one or more information handling system remote from well system 100, including information handling systems that are primarily used in the planning process for the stimulation operation. The fracture conductivity prediction tool may, for instance, comprise software executed by the information handling systems. As described herein, software may comprise a set of computer readable instructions executable by a processor of an information handling system. When executed, the computer readable instructions may cause the information handling system to perform one or more steps, which may include, but are not limited to, receiving data from one or more sources, processing the data using one or more algorithms, and displaying a result.

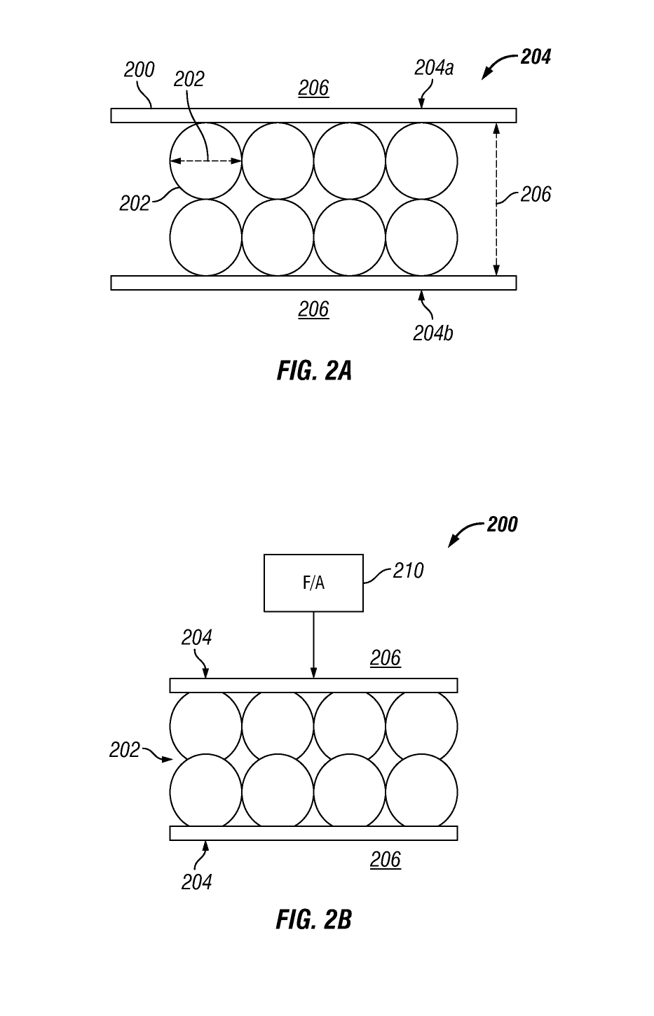

In certain embodiments, a fracture conductivity prediction tool and software related thereto may include steps directed to the implementation and simulation of a mathematical model for predicting fracture conductivity. FIGS. 2A and 2B are diagrams illustrating a graphical representation of an example mathematical model 200 used in a fracture conductivity prediction tool, according to aspects of the present disclosure. Although the model 200 is depicted as two-dimensional for ease of illustration, the model 200 may comprise a three-dimensional arrangement of proppant 202 positioned between two boundaries 204a and 204b that represent the sides of a fracture 204. The proppant 202 is represented by circles of the same size that are arranged in two layers aligned to form ordered columns between two parallel lines representing the boundaries 204a/b. The model 200 is not limited to the number, size, orientation, shape and dimension depicted, however. For instance, the model 200 may include proppant of shapes other than spherical, a proppant with non-uniform sizes. The model 200 may also include different numbers of proppant layers. Additionally, the proppant 202 within the model 200 may be arranged in an orderly manner that is different from the columns and rows depicted, or in a non-orderly or random arrangement, provided the arrangement is known. For instance, when the proppant 202 comprises a hexagonal or octagonal shape, the proppant may be ordered such that they fit together in a fixed pattern between the boundaries 204, or arranged randomly between the boundaries 204.

The model 200 may be characterized by one or more characteristics of the proppant 202, the fracture 204, and the subterranean formation 206 in which the fracture 204 is positioned. The proppant 202 may be characterized by a diameter 202a, a Young's modulus, a Poisson ratio, and sphericity. The proppant 202 used in the model 200 may have the same size and shape such that it can be characterized by one diameter, Young's modulus, Poisson ratio, and sphericity, or some or all of the proppant may be characterized by different diameter, Young's modulus, Poisson ratio, and sphericity values. The fracture 204 may be characterized by a fracture width 206, illustrated as the distance between the boundaries 204a and 204b. As depicted, the boundaries 204a/b of the fracture are parallel, such that a single fracture width 208 value may be used to characterize the fracture 204. The formation may be characterized by a Young's modulus, Poisson ratio, and fracture closure pressure 210, which may correspond to the pressure required to maintain the fracture 204 within the formation 206. As depicted in FIG. 2B, when the fracture closure pressure 210 acts of the sides 204a/b of the fracture 204, the fracture width 206 is reduced, causing the proppant 202 to shift and compress with respect to itself and the boundaries 204a and 204b.

The model 200 further may be characterized by a porosity or void fraction, which may comprise a measure of the void (i.e., “empty”) spaces between the proppant 202 within the fracture 204. The porosity or void fraction may depend, in part, on the fracture closure pressure 210. For instance, as depicted in FIGS. 2A and 2B, the voids between the proppant 202 and, therefore, the void fraction is larger when the fracture closure pressure 210 is not applied to the fracture 204 in FIG. 2A, and smaller when the fracture closure pressure 210 is applied to the fracture 204 in FIG. 2B due to the compression of the proppant 202.

In certain embodiments, the porosity or void fraction may be calculated using a discrete element method (DEM) contact model. Example contact models may, for instance, assume that the load on the proppant 202 by the fracture closure pressure 210 may be distributed evenly on the ordered columns. An example model may also assume that the proppant 202 will overlap (instead of breaking) with itself and the boundaries 204a and 204b when the fracture closure pressure 210, as depicted in FIG. 1. In certain embodiments, the overlap αₚ between the proppant 202 and itself may be calculated using the following Hertz-Mindlin equations:

$${α}_{p} = {( \frac{3}{4 E * \sqrt{\frac{{d}_{p}}{2}}} )}^{\frac{2}{3}} {( F )}^{\frac{2}{3}}$$

$${E}^{*} = ( \frac{1}{\frac{1 - {v}_{p}}{{E}_{p}} + \frac{1 - {v}_{p}^{2}}{{E}_{p}}} )$$

where vₚ comprises the Poisson ratio of the proppant; Eₚ comprises the Young's modulus of the proppant; dₚ comprises the proppant diameter; and F comprises the fracture closure pressure. Similarly, the overlap αᵣ between the proppant 202 and the boundaries 204a and 204b may be calculated using the following Hertz-Mindlin equations:

$${α}_{p} = {( \frac{3}{4 E * \sqrt{\frac{{d}_{p}}{2}}} )}^{\frac{2}{3}} {( F )}^{\frac{2}{3}}$$

$${E}^{*} = ( \frac{1}{\frac{1 - {v}_{p}}{{E}_{p}} + \frac{1 - {v}_{r}^{2}}{{E}_{r}}} )$$

where vᵣ comprises the Poisson ratio of the formation and Eᵣ comprises the Young's modulus of formation. Based on the above calculated values for the overlap αᵣ and the overlap αₚ, the void fraction φ may be calculated using the following equation:

$$ϕ = ( n - C ) \frac{π}{12} {a}_{p}^{3} + C * \frac{π}{12} {a}_{r}^{3}$$

where aₚ=(dₚ−αₚ); aᵣ=(dₚ−αᵣ); C comprises the number of columns in the model; and n comprises the number of proppant particles. Although the above equations are directed to a Hertzian contact model, it should be appreciated that equations directed to other DEM contact models may be used. Those other DEM contact models may include, but are not limited to, linear contact models, Pellet contact models, adhesive models, and concrete contact models.

According to aspects of the present disclosure, the model 200 may be associated with one or more equations that can be used to calculate an estimated fracture permeability of the fracture 204. For instance, the model 200 may be associated with one or more equations that may calculate an estimated fracture permeability based on one or more of the proppant, fracture, and formation characteristics associated with the model 200, such as the proppant diameter 202a, the proppant sphericity, the void fraction, and the fracture width 206. One example equation may take the following form:

$$\frac{k}{{d}_{p}^{2}} = \frac{{ϕ}^{3} {φ}^{2}}{72 {{λ}_{m} ( 1 - ϕ )}^{2}} {( 1 + \frac{φ {d}_{p}}{3 ( 1 - ϕ ) W} )}^{- 2}$$

where φ comprises the sphericity; k comprises the permeability; W comprises the fracture width, and λₘ comprises a tortuosity factor. This disclosure is not limited to the above equation, however, and other equations for calculating the permeability may be derived and used.

Notably, the equations may be used to quickly simulate and estimate the permeability of a fracture based on different characteristics of the proppant, fracture, and formation. For instance, the same fracture and formation may be tested with many different proppants to determine the proppant that maximizes the fracture permeability. That proppant can then be selected and used in practice without having to manually test each proppant. Moreover, the model 200 may include real-time measurements regarding the size and shape of the fracture, and the fracture closure pressure to provide an accurate context in which to test proppant value to maximize the fracture permeability. This may be useful in a multi-stage treatment, for instance, where a proppant can be quickly selected for upcoming treatment stages with knowledge of how the formation actually responded to a previous fracture treatment, rather than an idealized extrapolation.

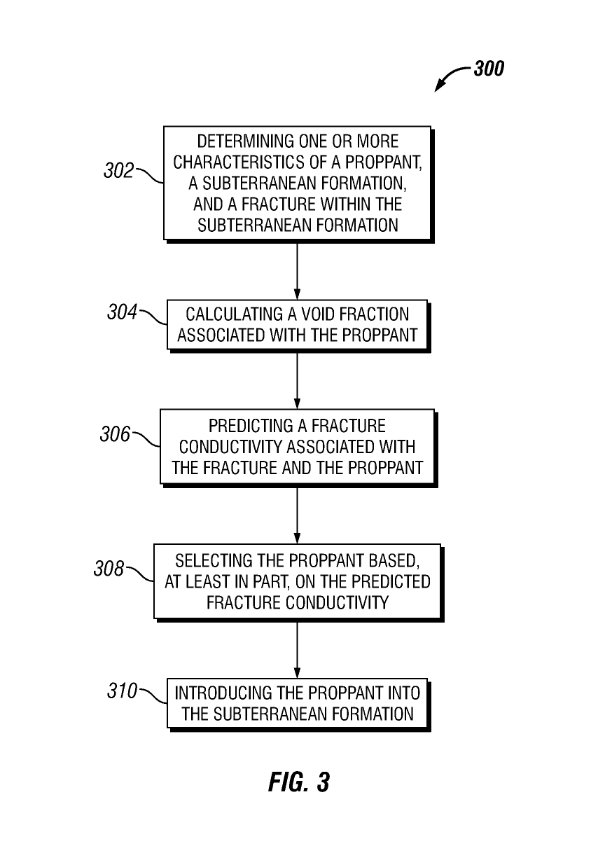

FIG. 3 is a flow diagram depicting an example method 300, according to aspects of the present disclosure. Step 302 may comprise determining or otherwise receiving one or more characteristics of a proppant, a subterranean formation, and a fracture within the subterranean formation. Determining one or more characteristics of the proppant may comprise determining a diameter of the proppant, a sphericity of the proppant, a Young's modulus of the proppant, and a Poisson ratio of the proppant. Determining the characteristics of the proppant may include, for instance, measuring one or more characteristics of the proppant, such as the diameter, Young's modulus, and Poisson ratio, and/or identifying characteristics of the proppant provided by the proppant manufacturer on a data sheet or some other supporting documentation.

In certain embodiments, determining one or more characteristics of the subterranean formation may comprise determining a fracture closure pressure, a Young's modulus of the formation rock, and a Poisson ratio of the formation rock; and determining one or more characteristics of the fracture may comprise determining a fracture width. The characteristics of the fracture and subterranean operation may be determined, for instance, through measurements received at an information hand ling system and/or through the simulation of one or more earth and fracture models that would be appreciated by one of ordinary skill in the art in view of this disclosure. The earth and fracture models may be used during planning stages of the fracture and stimulation operation, and may be supplemented with fracture and formation measurements generated during the fracture and stimulation operation. For instance, determining the fracture width may comprise one of simulating a fracturing operation and determining the fracture width of the simulated fracture; and determining the fracture width using downhole measurements generated after the fracture is induced in the subterranean formation, as described above with reference to FIG. 1.

Step 304 may comprise calculating a void fraction associated with the proppant using at least one determined proppant characteristic, at least one determined subterranean formation characteristic, and a model with a known arrangement of the proppant. In certain embodiments, the model may comprise a model the same as or similar to the model described above with respect to FIGS. 2A and 2B, but other model configurations are possible. Step 306 may comprise predicting a fracture conductivity associated with the fracture and the proppant based, at least in part, on the calculated void fraction and at least one determined fracture characteristic, such as the fracture width. In certain embodiments, a predicted fracture conductivity may be calculated using equation (2) using the variable describe above with reference to that equation. Equation (2) is only one embodiment of potential models/equations that can be used to predicting fracture conductivity, however, and it not intended to be limiting.

Step 308 may comprise selecting the proppant based, at least in part, on the predicted fracture conductivity. As described above, the model/equation may be used to calculate a predicted fracture conductivity for a variety of different proppants. Based on these determinations, one or more of the proppants that maximize the predicted fracture conductivity may be selected to be introduced downhole at step 310. In certain embodiments, the model/equation may be simulated/run at different times of the planning and fracturing/stimulation process to select the proppant. For instance, the process may be implemented during a planning stage based on simulated earth and fracture models to select a first proppant to be introduced into the formation. The process may be run again during the fracturing/stimulation process based on measurements generated during a first treatment stage to determine if the proppant selected during planning is ideal for the actual downhole conditions, or if another proppant should be used. Additionally, the process may be used in combination with a reservoir simulator to predict the productivity of the reservoir post stimulation. This may be useful, for instance, if there was an inaccuracy in the earth/fracture model used during the planning stages such that the fracture and formation characteristics to predict fracture conductivity were incorrect and skewed the predicted fracture conductivity associated with the proppant selected during that stage.

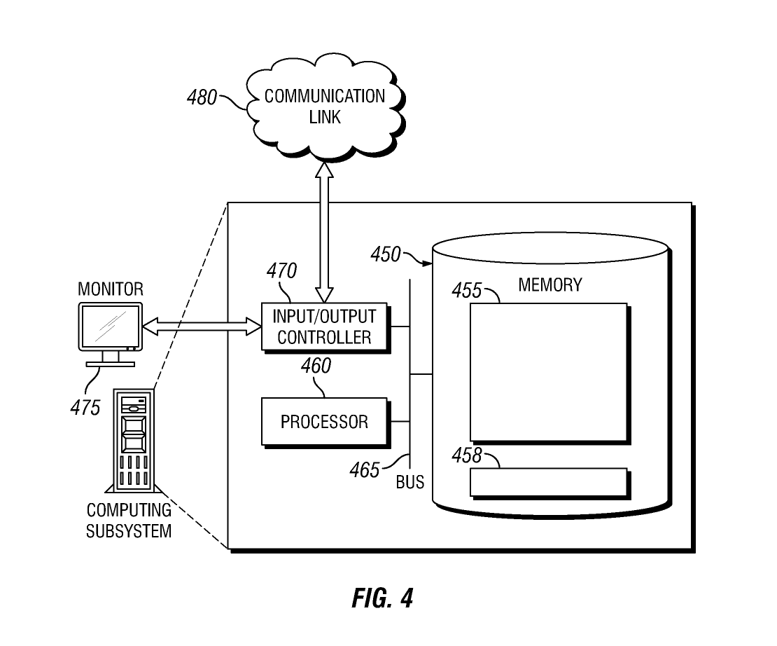

As described above, the model/equations and certain aspects of the processes described above may be implemented as software in one or more information handling systems. These information handling systems may include, for instance, the information handling systems described above with reference to FIG. 1. FIG. 4 is a diagram illustrating an example information handling system 400 in which the process/model may be implemented, according to aspects of the present disclosure. The example system 400 includes a memory 450, a processor 460, and input/output controllers 470 communicably coupled by a bus 465. The memory 450 can include, for example, a random access memory (RAM), a storage device (e.g., a writable read-only memory (ROM) or others), a hard disk, or another type of storage medium. The system 400 can be preprogrammed or it can be programmed (and reprogrammed) by loading a program from another source (e.g., from a CD-ROM, from another computer device through a data network, or in another manner). In some examples, the input/output controller 470 is coupled to input/output devices (e.g., a monitor 475, a mouse, a keyboard, or other input/output devices) and to a communication link 480. The input/output devices receive and transmit data in analog or digital form over communication links such as a serial link, a wireless link (e.g., infrared, radio frequency, or others), a parallel link, or another type of link.

The communication link 480 can include any type of communication channel, connector, data communication network, or other link. For example, the communication link 480 can include a wireless or a wired network, a Local Area Network (LAN), a Wide Area Network (WAN), a private network, a public network (such as the Internet), a WiFi network, a network that includes a satellite link, or another type of data communication network.

The memory 450 can store instructions (e.g., computer code) associated with an operating system, computer applications, and other resources. The memory 450 can also store application data and data objects that can be interpreted by one or more applications or virtual machines running on the system 400. The example memory 450 includes data 455, and applications 458. The applications 458 can include software applications, scripts, programs, functions, executables, or other modules that are interpreted or executed by the processor 460. The applications 458 may include machine-readable instructions for performing one or more of the operations described below. The applications 458 can obtain input data, such as fracture, formation, and proppant characteristics or other types of input data, from the memory 450, from another local source, or from one or more remote sources (e.g., via the communication link 480). The applications 458 can generate output data and store the output data in the memory 450, in another local medium, or in one or more remote devices (e.g., by sending the output data via the communication link 480). As depicted, the applications 458 may include instructions used to implement one or more processes for a fracture conductivity prediction tool, as described herein.

The processor 460 can execute instructions, for example, to generate output data based on data inputs. For example, the processor 460 can run the applications 458 by executing or interpreting the software, scripts, programs, functions, executables, or other modules contained in the applications 458. The processor 460 may perform one or more of the operations to implement one or more processes for a fracture conductivity prediction tool, as described above.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces. The term “gas” is used within the scope of the claims for the sake of convenience in representing the various equations. It should be appreciated that the term “gas” in

What is claimed is:

1. A method, comprising:
determining one or more characteristics of a proppant, a subterranean formation, and a fracture within the subterranean formation;
calculating a void fraction associated with the proppant using
at least one determined proppant characteristic,
at least one determined subterranean formation characteristic, and
a model with a known arrangement of the proppant;
predicting a fracture conductivity associated with the fracture and the proppant based, at least in part, on the calculated void fraction and at least one determined fracture characteristic;
selecting the proppant based, at least in part, on the predicted fracture conductivity; and
introducing the proppant into the subterranean formation.

2. The method of claim 1, wherein determining one or more characteristics of a proppant comprises determining a diameter of the proppant, a sphericity of the proppant, a Young's modulus of the proppant, and a Poisson ratio of the proppant.

3. The method of claim 1, wherein determining one or more characteristics of the subterranean formation comprises determining a fracture closure pressure.

4. The method of claim 1, wherein determining one or more characteristics of the fracture comprises determining a fracture width.

5. The method of claim 4, wherein determining a fracture width comprises one of
simulating a fracturing operation and determining the fracture width of a simulated fracture; and
determining the fracture width using downhole measurements generated after the fracture is induced in the subterranean formation.

6. The method of claim 1, further comprising
determining one or more characteristics of an other proppant;
calculating a void fraction associated with the other proppant using
at least one determined characteristic of the other proppant,
at least one determined subterranean formation characteristic, and
the model that assumes an ordered arrangement of the other proppant;
predicting a fracture conductivity associated with the fracture and the other proppant based, at least in part, on the calculated void fraction associated with the other proppant and at least one determined fracture characteristic; and
selecting between the proppant and the other proppant based, at least in part, on the predicted fracture conductivity of the proppant and the predicted fracture conductivity of the other proppant.

7. The method of claim 1, further comprising
determining one or more characteristics of an other fracture;
predicting a fracture conductivity associated with the other fracture and the proppant based, at least in part, on the calculated void and at least one determined characteristic of the other fracture; and
selecting between the proppant and the other proppant based, at least in part, on the predicted fracture conductivity of the proppant and the predicted fracture conductivity of the other proppant.

8. The method of claim 1, wherein determining one or more characteristics of the proppant, the subterranean formation, and the fracture within the subterranean formation comprises determining one or more characteristics of the proppant, the subterranean formation, and the fracture within the subterranean formation using at least one of an earth and/or fracture model and measurements generated during a fracturing and stimulation operation.

9. The method of claim 1, further comprising predicting the productivity of the well after the proppant is introduced into the subterranean formation.

10. The method of claim 1, wherein
selecting the proppant based, at least in part, on the predicted fracture conductivity comprises selecting the proppant for a first stage of a stimulation operation; and
the method further includes the step of selecting a different proppant based for a second stage of the stimulation operation based, at least in part, on the model.

11. A system, comprising:
an injection system positioned proximate a wellbore in a subterranean operation;
an information handling system communicably coupled to the injection system, the information handling system comprising a processor and a memory device, the memory device containing a set of instructions that, when execute, cause the processor to
determine one or more characteristics of a proppant, a subterranean formation, and a fracture within the subterranean formation;
calculate a void fraction associated with the proppant using
at least one determined proppant characteristic,
at least one determined subterranean formation characteristic, and
a model that assumes an ordered arrangement of the proppant;
predict a fracture conductivity associated with the fracture and the proppant based, at least in part, on the calculated void fraction and at least one determined fracture characteristic;
select the proppant to be introduced into the wellbore based, at least in part, on the predicted fracture conductivity.

12. The system of claim 11, wherein the set of instructions that cause the processor to determine one or more characteristics of a proppant further causes the processor to determine a diameter of the proppant, a sphericity of the proppant, a Young's modulus of the proppant, and a Poisson ratio of the proppant.

13. The system of claim 11, wherein the set of instructions that cause the processor to determine one or more characteristics of the subterranean formation further causes the processor to determine a fracture closure pressure.

14. The system of claim 11, wherein the set of instructions that cause the processor to determine one or more characteristics of the fracture further causes the processor to determine a fracture width.

15. The system of claim 14, wherein the set of instructions that cause the processor to determine a fracture width further causes the processor to one of
simulate a fracturing operation and determining the fracture width of a simulated fracture; and
determine the fracture width using downhole measurements generated after the fracture is induced in the subterranean formation.

16. The system of claim 11, wherein the set of instructions further cause the processor to
determine one or more characteristics of an other proppant;
calculate a void fraction associated with the other proppant using
at least one determined characteristic of the other proppant,
at least one determined subterranean formation characteristic, and
the model that assumes an ordered arrangement of the other proppant;
predict a fracture conductivity associated with the fracture and the other proppant based, at least in part, on the calculated void fraction associated with the other proppant and at least one determined fracture characteristic; and
select between the proppant and the other proppant based, at least in part, on the predicted fracture conductivity of the proppant and the predicted fracture conductivity of the other proppant.

17. The system of claim 11, wherein the set of instructions further cause the processor to
determine one or more characteristics of an other fracture;
predict a fracture conductivity associated with the other fracture and the proppant based, at least in part, on the calculated void fraction and at least one determined characteristic of the other fracture; and
select between the proppant and the other proppant based, at least in part, on the predicted fracture conductivity of the proppant and the predicted fracture conductivity of the other proppant.

18. The system of claim 11, wherein the set of instructions that cause the processor to determine one or more characteristics of the proppant, the subterranean formation, and the fracture within the subterranean formation further cause the processor to determine one or more characteristics of the proppant, the subterranean formation, and the fracture within the subterranean formation using an earth and/or fracture model.

19. The system of claim 11, wherein the set of instructions that cause the processor to determine one or more characteristics of the proppant, the subterranean formation, and the fracture within the subterranean formation further cause the processor to determine one or more characteristics of the proppant, the subterranean formation, and the fracture within the subterranean formation using measurements generated during a fracturing and stimulation operation.

20. The system of claim 11, wherein
the set of instructions that cause the processor to select the proppant based, at least in part, on the predicted fracture conductivity further causes the processor to select the proppant for a first stage of a stimulation operation; and
the set of instructions further cause the processor to select a different proppant based for a second stage of the stimulation operation based, at least in part, on the model.
